(19) United States
(12) Patent Application Publication
(10) Pub. No.: US 2012/0143640 A1
(43) Pub. Date: Jun. 7, 2012

(54) TRACEABILITY SYSTEM APPLIED TO FARM PRODUCTION ACTIVITIES, INDUSTRIALIZATION AND COMMERCIALIZATION OF BEE PRODUCTS

(75) Inventors: Ricardo Alexandre Da Silva Shimabukuro Victorio, Sao Paulo (BR); Gustavo Vilela Vargas, Sao Paulo (BR); Fernando Augusto Chufi, Sao Paulo (BR); Thiago Yoshihiro Ito Takahashi, Sao Paulo (BR); Fábio San Juan, Sao Paulo (BR); Caluã de Lacerda Pataca, Sao Paulo (BR); José Luis Ponciano Bomfim, Sao Paulo (BR); Adriana Ramos, Sao Paulo (BR); Guilherme de Oliveira Feliciano, Sao Paulo (BR); Maria Cristina Marcucci Ribeiro, Sao Paulo (BR)

(73) Assignees: FUNDACAO DE AMPARO A PESQUISA DO ESTADO DE MINAS GERAIS-FAPEMIG, Minas Gerais (BR); UNIVERSIDADE FEDERAL DE LAVRAS, Minas Gerais (BR)

(21) Appl. No.: 12/596,612

(22) PCT Filed: Apr. 18, 2008
(86) PCT No.: PCT/BR08/00112

§ 371 Date: May 24, 2010

(30) Foreign Application Priority Data
Apr. 18, 2007 (BR) PI 0701450.3

(51) Int. Cl. G06Q 10/06

(52) U.S. Cl. 705/7.11

(57) ABSTRACT

is a technological solution that mixes administrative, computational and electronic engineering knowledge, and aims to modernize the whole apicultural production chain. The administrative part of the ensemble proposes the use of small electronic equipment for all the activities of the field and industrial jobs. The equipment is carried attached to the user's body, in such a manner that its presence influences the minimum possible in the user's quotidian activities, maximizing its ergonomics quality. The equipment can be activated without using hands. Still from an administrative point of view, logistic processes for transferring and storing items, coupled with a complex but intuitive system of classes and subclasses of codes, assessed and monitored by the electronic equipment, register everything, in an automatic and inductive manner, leading the user to an inevitable recording of all the details in its daily activities. The computational and electronics knowledge used make possible that all the details idealized to register activities, the transfers and assets used, can be executed in practice. The result of the use of this solution is a conscious consumer, aware of the quality of the products consumed, a producer who is able to highlight the quality of his products produced with care, and a sector that learns how to know its potentials and can have modern and efficient tools to augment its productivity.

This patent demand refers to a system which aids the registering important data, in details, during the development of the activities in apicultural farming, production, harvesting, processing, storing, industrialization and commercialization of products in this sector, allowing these processes to be traced. This work will give the possibility to the companies of the sector to optimize the use of their assets and processes, as well as to control and highlight the quality of their products. Such companies will be induced to a growing professionalization degree. To the consumers and industrial market of the sector, national or international, the system will offer much more precise information about dates, conditions and production processes used for the products being acquired, which increases reliability about their quality.

The system is made viable by the introduction of a novel, portable tracer equipment, with embedded software, specifically developed for this task. The equipment can easily be carried by the user while his hands are free for the activities in the farm. It goes attached to the user's body, it is easy to use, and it offers precision and reliability to the collected data, avoiding their adulteration. The operation of the equipment is complemented by software for the management of the information collected in the field and by logistic and security processes here described and claimed.

One can conclude that the traceability system claimed has been provided by inventive activity, by guaranteeing odd easiness and reliability in entering data in the field, in accord with the requirements for patenting, as disposed by the Patent Cooperation Treaty (PCT).

### TECHNICAL FUNDAMENTALS

in order to provide a better understanding about the subject and the solution here proposed, we will present an interpretation of the concept of traceability used nowadays for tracing products in this sector. Then, we will detail the solution here proposed, discussing about the advantages aggregated with the introduction of this novel traceability system, trying to highlight the advantages of this innovation.

The concept of Traceability is based on the act of registering, in details, all the assets and the activities executed along a production process along time, so that, if necessary, the process can be reviewed and evaluated, allowing it to be ameliorated, and being transparent on how the final product has been obtained. The importance of this term has increased by the last years, due to the increased competition in production activities and to the commercial practices and governmental policies that encouraged global markets, with a consequent increased need for competitive power. The tracing of processes allows one to find and correct, precisely and fast, any variety of error occurred during the production, which influence directly on the quality of the final products and the efficiency of the production. This practice also allows the consumers of the product to analyze its quality since the beginning of its production.

Apiculture as a primary activity in the economy, and the secondary and tertiary activities of this sector, seen in a global context, have been signing the intention and the need of adhering to the techniques of traceability, looking for a differentiate in the reliability of the final product commercialized.

In a study, we have verified that, in the state of the technique, the apicultural sector has available two systems used to trace the steps of the production en its products. The first one being the traditionally used paperwork and pencil or pen for pointing what is convenient, and later transferring such annotations to digital or even manual spreadsheets. The second option available in the market uses optionally an electronic data collector and software for processing and storing of the obtained information. The second option is not less difficult and inefficient than the manual system described previously, because:
since the use of the data collector is optional, the system that process and stores traceability information also accepts the manual insertion of data, which also means that these data may be inserted intentionally, according to the user's interest;
since the data collector accepts manual insertion of data, it offers to the user only the option of exchanging its notepad by an electronic equipment, and it does not offer any additional security to the system, and it also allows the user to insert data in accordance with his convenience;
about the data collector equipment used, although it does not need to be carried in hands, since it can be attached to the user's body, at the moment of operating it, it must be carried by one hand while the other hand pushes its buttons to choose its functions in a menu bar, type information or read bar codes or RFIDs (Radio Frequency IDs) from labels previously affixed to the materials in use;
an analysis of these conditions allows us to conclude that such traceability equipment causes a discomfort to the operator in its use, because it must be periodically carried in hands to be operated, which collaborates for reduced use/operational ergonomics, and compromises the productivity and the motivation of the operator in keeping registering data for traceability;
finally, the system in use depends on the memory of the operator for the information to be registered.

The traceability system here proposed has been elaborated based on the premises and deficiencies described in the following, and the proposed solution looks for an optimization of the conditions of use in the field:
The cultural conditions of the professional—in majority, beekeepers are rural workers, with a low instruction level and consequently low affinity with electronic instruments, and resistance to perform annotations;
The distance between the various workplaces—there are tens to hundreds of apiaries, distant by tens to hundreds of kilometers, from the operational base;
Bad visual, hearing and handwork conditions—the worker, to realize production activities in apiculture, must daily wear overalls that cover its body from feet to the top of the head, with thick protection gloves that limit his tact, and with a veil for protecting his face against bees, which is posed between his eyes and the landscape around him, limiting his vision; finally, this professional works along the greater part of his activities in the apiary, surrounded in the level of his eyes, by tens or hundreds of bees, buzzing and colliding frenetically against the protecting veil;
Overused hands—due to the excessive use of the hands for works of carrying, affixing, taking, cleaning, and constantly carrying the bellows for producing smoke and a spatula for opening beehives and moving hive frames (frames in the beehive) which are glued to the beehive by wax or propolis;
Difficulty of typing in electronic instruments—this professional is usually wearing thick gloves, dirtied by honey, wax, propolis, land, and bees keep flying insistent and aggressive around this region (fingers), attracted by the smell from bees that have been occasionally killed during the manipulation;
Bad ventilation, temperature and humidity conditions—the worker is exposed to a temperature many times superior to 40 degrees Celsius, with low air circulation due to the overalls previously described, and in some cases, he executes tasks under rain, wind and other difficult climate conditions;
Security of collected data—the sector needs to offer safe information and unquestionable by the market, about its product.

### INVENTION PROPOSAL

in face of the technical fundamentals exposed above this patent's inventors have idealized a traceability system applied to the activities in apiculture, which differentiates from any system available in the state of the technique in this application field, where the invention solves deficient aspects previously identified and detailed, by presenting the following characteristics:
The traceability system does not operate with manual annotations;
The adopted equipment for field work is of easy and intuitive use;
The equipment is not carried or operated by hands;
The use of the equipment in the field does not depend on the vision and the thinking of the operator;
The traceability system has processes and operational proceedings, internal and external, well defined, intuitive and inductive;
The inductive processes conduct the user to collect information to be registered;
The professional has no additional manual activities and no interferences in his daily routine;
The system does not accept manual inserted data and it contains security subsystems that avoid the adulteration or intentional manual data insertion;
It contains complementary security subsystems, among physical, digital and statistical analysis of data;
The new equipment developed and claimed, just like the one available in the state of the technique, is carried attached to the worker's body, but as a differential, it does not need to be carried in hands to be operated, since the equipment module that reads identification codes (bar codes or RFIDs) is attached on the back of one of the worker's hands. It is affixed on the user's glove in such a manner that, for reading codes, the user's just needs to point the arm in the direction of the target, with the advantage that it keeps the hands free. It constitutes a novel condition of use/operational ergonomics;
When pointing the arm (on which the code reader is attached) in the direction of the target (identification label) the user, different from the equipment of the state of the technique, does not need to use the other hand to activate the identification code reader, but with the hand of the same arm (pointed to the target), specifically with the thumb, he will press a button placed on the glove, in the lateral of the index finger of the same hand (this button activates the optical or RFID reader);
In the system here proposed, also different from the state of the technique, the operator does not need to type information, which avoids touches for data insertion, since in this equipment, data are collected according with a model of linking of classes and subclasses of identification codes (bar codes or RFID) previously established and claimed in this document;
Occasionally and in special operation conditions, the user may select other functions of the equipment, by pressing another button, also available on the glove, in the lateral of the index finger, close to the button cited previously, and there is no need for the second hand neither in this case;
In this proposal, for strategic reasons, and for standardization of methodologies, security and the reliability of the processed data, it is mandatory the use of the inventive equipment by the operator for acquiring data, and the manual insertion of data is not allowed in any way.

This condition avoids the non-insertion (forgetting) of primordial data, yet offering reliability to the acquired data, since this equipment has an obligatory and/or involuntary sequence of data acquisition.

In addition, it must be highlighted that the inventive equipment does not allow data insertion by typing, and it has no touches for such purpose.
For security in data acquisition the traceability equipment has a module that records date and time every time it is physically opened, making harder the fabrication of data (insertion of not true data in the system);
For the validation of data inserted in the system, the equipment is serially numbered, and qualified periodically (in order to verify that it has not been violated);
The hardware (equipment) used for data collection in the field has a fix residence local (like the base of a wireless phone), and when it is removed from its residence, it must receive the identification of the card of an authorized person (otherwise it must emit sound or light alarms); in the sequence it must ask more requirements to the operator, inducing him to insert important information that could be forgotten.
The functional logic embedded in the new inventive hardware is based on the identification in classes and subclasses of identification codes, in such a manner that the applicative software only links the information of an identification code to another identification code if such class and subclass relationship is expected. So, the simple act of pointing the arm and press a button on the glove to read an identification code, followed by the reading of another code, the second code is automatically linked to the first code, with a previously established processional meaning. In such a way, the operator does not need to select function in its hardware an to insert data by typing;
For information security reasons, the equipment has the function of analyzing operational data and correlating them with parameters acquired by experience and use, performing a statistical analysis of data in order to validate the authenticity of the acquired data.

### FIGURES DESCRIPTION

to complement the present description for a better understanding of the characteristics of the present invention deposit, attached to this document, in annex, there is a set of figures, where in an illustrative, but not limiting manner, a preferred realization form for the traceability and data collector equipment claimed has been represented, where:

FIG. 2 is an illustrative representation of the traceability hardware attached to the overalls for apicultural activities of the operator;

The Detail 1 is a representation, as a zoom, of the traceability equipment attached to the gloves for apicultural activities of the operator;

FIG. 1 is an illustrative representation of the traceability equipment in a rest position, on a special base, installed in the interior of an operational central; and

FIG. 3 is an illustrative representation of the use of the hardware (HW) while collecting data in the field, and the relationship of that hardware with the management software in the operational base, for exchanging data.

### DETAILED DESCRIPTION

the following detailed description must be read an interpreted with reference to the figures presented. Such figures are illustrative and represent a preferred form of realization. They are not supposed to limit the invent scope. The scope is limited exclusively by the claim table.

While referring to the illustrations, the present invention patent demand refers to a differentiated traceability system, applied to the apicultural sector, whose functionality is guaranteed by the introduction of novel traceability equipment (A). When not in use, A is set to a rest state, on a base (A1). The base A1 is installed in the interior of an operational management central (C), such as illustrated in FIG. 1.

The traceability equipment (A) is composed by a hardware (HW) with a GPS, and supports an applicative software (SW), and in addition to this hardware a bar code reader (LCB) is attached, as well as a RFID reader.

In complement, an activation button (A3) is available for the code reader (LCB), placed on the glove (B1), specifically on the lateral of the index finger (B3). To be activated, B3 can easily be pressed by the thumb (B2), as illustrated in Detail 1. This activation button (A3) communicates with the traceability equipment (A) by a physical line, such as a communication cable, or by a remote wireless connection.

While in use, the traceability equipment (A) will emit a continuous sound alarm as soon as it is detached from the base (A1), and the sound alarm will not stop until the user identifies himself, by his identification card. From this event on, A starts registering date, time and GPS coordinates of every event. While the equipment is in operation, but the user is still without the special wearing, consequently without gloves and without the activation button, the traceability equipment can be operated to acquire data, by the selection of functions in an appropriate button on the equipment.

As part of the action of detaching the traceability equipment (A) from its base (A1), the user will be asked to inform (via code reading) the human resources that will help him in the subsequent tasks and the vehicle to be used. The information about the places to be visited, as well as the activities to be executed, will already be available to the team leader in the hardware (HW), since they have been programmed a priori by the administrator. The information about the materials to be used and their location in the warehouse will also be available. This initial condition eliminates the dependency on the memory of the operator, who should take notes about this information. If the information is not introduced, the traceability equipment (A) will keep emitting the sound alarm and will not accept the introduction of any other data.

The information acquired by the traceability system is validated with the registered GPS coordinates, remembering that the traceability equipment (A) guarantees the integrity of data by security systems.

The operational management central (C) could also have a real time communication with the user which cares the traceability equipment (A) by wide area wireless technologies.

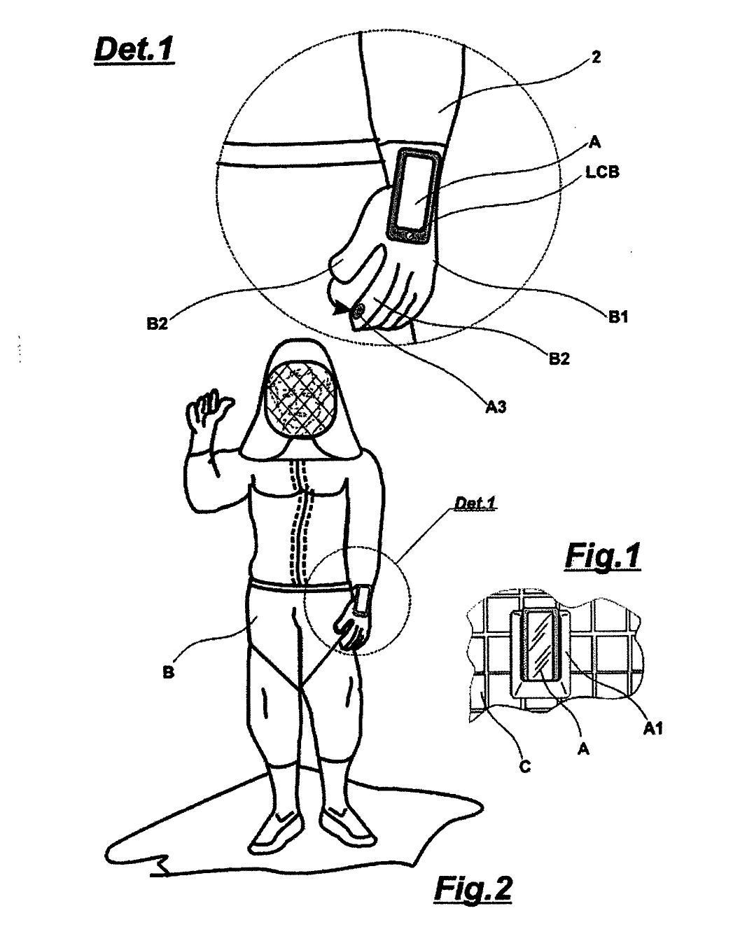

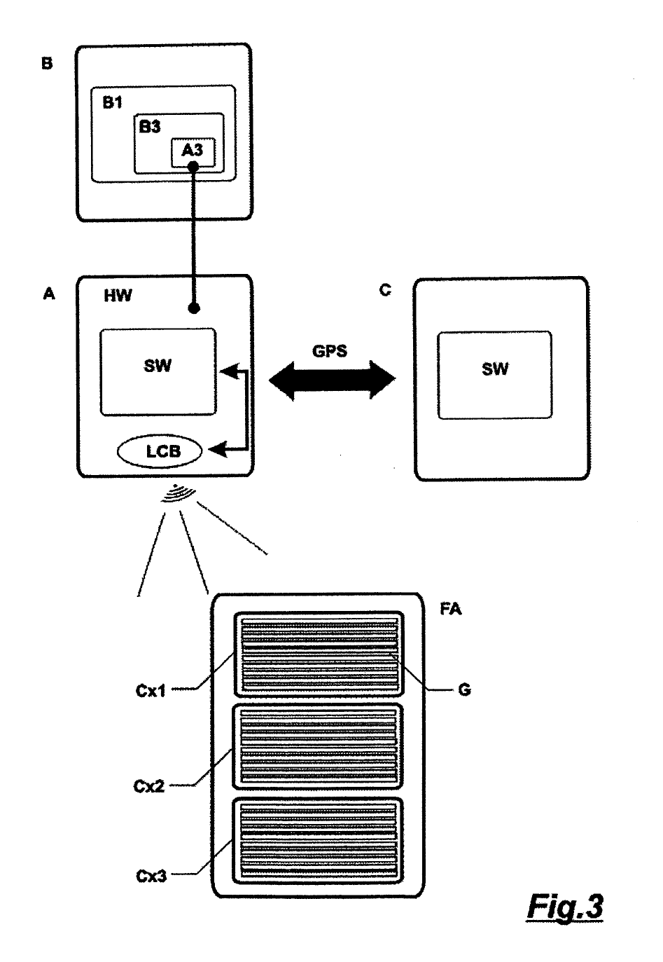

Since the startup information has been registered, the traceability equipment (A) is attached to the special apiculture overalls (B), specifically on one of the gloves (B1) which integrates the user wearing. Such attachment is done on the back of the user's hand, as illustrated in FIG. 2. The worker, already in working condition and wearing correctly, must initiate his activities by using the previously established procedures, and performing code reading in accordance to such procedures. Each procedure has a specific meaning as described in this document. To perform code reading, the user will only need to point the arm that carries the code reader (bars or RFID) attached to the glove (B1) to the identification label and press the button on the glove. The hands remain free.

Classes and subclasses of identification codes: the applicative software (SW) installed in the traceability equipment (A) and the management software (SWG) installed in the computer of the operational management central (C) are programmed to acquire data by reading sequences of codes (bars or RFID) which are transformed in specific information each action or inspection executed during the visit of the operator to the apiary or in his tasks in the operational base. In the following some basic operational rules and some patterns adopted are described:

Functional Premises for Internal and External Workplaces:
(P1) when the code of an external (4) or internal (5) local is read, and the code read in the sequence is a code of the same class (4) for (4) or (5) for (5), it will mean to the system that in this apiary (4) or section (5), nothing has been done, nothing has neither been removed nor inserted there, and the system can close the first read apiary or section by registering no change, and it can open the second. Always when a job is being done in an external (4) or internal (5) local and, after any operation, another code 4 (for 4) or 5 (for 5) is read, the system will interpret as finished that job, and another job is beginning in the other local (4 or 5) recently red; in case of external job, the system will always cross data with the GPS coordinates read, validating or not the operation;
(P2) when a code of material is read (ex: 7; 8.1; 8.2; etc) and the material integrates an external local (4), the system will interpret that this job is being executed in that local (4) not depending on the reading of the code of (4); if during this job another code of material is read (ex: 7; 8.1; 8.2; etc) and the material integrates another external local, the system will understand that the job in the previous external local is finished, and another job has started in the second external local, always validating with GPS coordinates; the same occurs with internal jobs, and always when a code of material, tool or consumable is read, and the code read integrates a section (5), the system will understand that the job is being executed in this section, not depending on the reading of the section code;
(P3) when materials are moved from internal to internal places (5), from internal (5.2.1; 5.2.2) to external (4) places, from external to external places, from internal places (5.2.1; 5.2.2) to bee families (7), or from bee families to bee families, first we read the code of who is receiving the material (integrating unit UI) and in the sequence we read the codes of all items being moved; this means to the system that the materials were all transferred to the entity (UI) identified by that code; (P3*)=exception.
(P4) when bee families (7) are being transferred between external locals (4), the above rule (P3) is also valid; it is sufficient to read the code of the external (4) local (UI), followed by reading the codes of all bee families and it will mean that all bee families have been transferred to this local; GPS coordinates will confirm the operation;
(P5) when materials are placed on an internal transport vehicle (6.1.1) the users may proceed in two manners:
   1—if the materials do not need individual registering in the sections where they will pass, the vehicle code can be read and the subsequent reading of the code of the materials will mean that the materials are on the vehicle for each section the vehicle pass by; the codes of the materials do not need to be read, it is sufficient to read the code of the section followed by the code of the vehicle and it will mean that all the vehicle content has passed by there;
   2—if the materials need individual registering in a section where it passes by, the vehicle may be used only for transport, and reading its code is unnecessary; the materials must simply be placed on the vehicle and transported to the destiny section, where the code of the section or of an item (tool or consumable) is read followed by the codes of the materials, and it will mean that the materials have been there and they have received the required treatment;
(P6) supplies that have already been transferred from storage to a section by means of procedures (P3) and (P5), may have their codes read followed by the reading of codes of materials, which will mean to the system that those materials have used those supplies or, depending on the supply and the kind of the material, it will mean that the material contains that supply; when a new pack of supplies starts being used, its code must be read, and the system will understand that the latest pack is finished and the new pack is open;
(P7) every new material, tool or supply acquired must be registered in the system by the registering and code generation section of the administration department, and a code must be generated and sent to the reception where the item is entering; this will mean to the system that from this moment on, that item exist in the company (5.2.2); after receiving notification from the reception (5.2.2) about an item with damaged code, the administration must open an internal report informing the (optional) pyrographic number and the number of the damaged code, and a new code must be generated and sent to the reception (5.2.2);
(P8) optionally the companies who acquire the system may opt for pyrographic in numeric sequence all his items; if it is done, any new item entering the company must receive such number, which must be automatically associated to the identification code; the aim of this identification is to reference items in case of labels lost and additionally it will serve as patrimony identification;
(P9) for each product lot received for improvement, the receptionist (5.3.1.1; 5.3.2.1; 5.3.3.1; 5.3.4.1; 5.3.5.1; 5.3.6.1) will only start this process after receiving information from the administration (5.1R) (P10) about how to proceed for tracing selection; It can be performed per family (7), per apiary (4) or per region containing apiaries (4), and if it is by one of those criteria, independent of the product, the employee must read the codes of the hive frames (or other material containing the product) and the HW will automatically do the selection, choosing differentiate output (P12) sub-areas, according to the programmed selections; if there is the need for a pre-selection by color or flowery, the employee must first choose the output sub-areas where it will set the colors and flowery, and in the sequence he will choose visually the product contained in the hive frame (or material containing the product), and perform the reading of their codes, in accordance with the different sub-areas, and preceded by the sub-areas codes; the product can be put available for the subsequent section of improvement by (P3) or (P5); in the following we describe the possibilities of selection and pre-selection per product:
For honey: per family (7), per apiary (4), per region containing apiaries (4), per color or per flowery
For propolis: the selection is possible only per family (7), per apiary (4), per region containing apiaries (4); selections per color and per size are performed by instruments or manually in another section, after being done the selection per one of the three of the above criteria;
For pollen: per family (7), per apiary (4), per region containing apiaries (4), per color;
For royal jelly: per family (7), per apiary (4), per region containing apiaries (4);
For poison: per family (7), per apiary (4), per region containing apiaries (4);
For wax: per family (7), per apiary (4), per region containing apiaries (4), per flowery (color);
(P10) every internal or external employee that carries a traceability equipment (HW) must consult his daily agenda in the beginning and during the whole journey, following the steps indicated by the HW for the execution of each task;
(P11) every section in the storage department (5.2) or in the product improvement (5.3) department, must contain sub-divisions painted on the ground (sub-areas) with specific sub-codes, working as localization address inside the section;
(P12) other sections in the storage department or in the product improvement department must some information besides the sub-divisions painted on the ground (sub-areas) with specific sub-codes, working as localization address inside the section. They must contain also a differentiation per entrance or exit sub-areas; this differentiation of sub-areas inside the section aims to aid the differentiation of the destiny of the received materials (in the entrance sub-area), after being processed in the section to be put available for another section (in the exit sub-area);
(P13) every external employee (1) when getting the expedition material (5.2.1) to take to the field, must perform the reading of the code of the sub-area where the expedition material was got. It will mean to the system that all the material has be taken from that place and from this moment on the HW will only accept codes of field work; the same employee (1) must, when returning from the field, put in a reception sub-area (5.2.2) booked by the system by (P10) all the empty material left, and perform the reading of the code of the sub-area where it has been put, it will mean to the system that the empty material that came back from the field is now in that local; besides the goal for traceability, this reading has the additional goal of communicating to the system that in that local there are materials returning from the field and the materials must be traced, conditioned and then stored; the same employee (1) when returning from the field, must put in the department of product improvement, all the material containing products, at the entrance sub-areas (P12) in the specific receptions (5.3.1.1 to 5.3.6.1) and read the codes of the sub-areas where the products have been put; this will mean to the system that every product taken from the field by this team is available in that local and this information also signs to the system that the product available needs to be separated by (P9) or informs to the administration (5.1R) that there is a product waiting for a decision to be processed;
(P14) for each product lot received in sections (5.3.1.2; 5.3.2.3; 5.3.3.3; 5.3.4.3; 5.3.5.2; 5.3.6.3) the employee of this local must receive information from the administration (5.1L) via equipment (HW) about how he must proceed with eventual needs or possibilities of mixing lots; independent of the criterion used by the administration, the information about the procedures to be adopted for mixing lots must arrive to this employee via HW (P10);

In the following we describe the sequences of submission and linking classes and subclasses of codes and their functioning:

Class of employee (authorized to carry equipment HW) operator of the equipment (1)—only these employees are authorized to carry the traceability equipment (A), and this code is the only able to initialize the operation of A, specially the operation of the hardware (HW); this code works as an “unlock key” for detaching the equipment from its base (A1); in the code sequences, this is the only able to startup the equipment and if another person does this, the equipment will emit sound and/or light alarms until a code of this type is read; by (P10) when consulting the agenda in the HW, it must contain the indication of the journey route, the team components, the tasks of the day, as well as the materials that must be taken and in what address or sub-area of the expedition they are available;

Class of other employees (2)—after the hardware (HW) has been initialized and the code of the team leader has been inserted, HW will accept only the code of other employees, indication the creation of a work team; if there is no team but only the team leader, the user must inform it to the equipment via the command button, unlocking the equipment so it can accept the code (3), but nothing forbid another employee to be integrated to the team afterwards;

Class of vehicles (3)—at this moment, if the booked work is external, the equipment will accept only the code (3) which indicates the vehicle that will execute the transport, and the external employee must so, as an obligatory step, consult his agenda in the equipment (HW) and verify in which sub-area of the expedition of materials (5.2.1) the material needed for his journey is available, get it from such local and perform the reading of the code of the local, confirming the act of taking them; from this moment on the equipment will only accept codes of workplaces of class (4); if the work is internal, automatically the equipment will not require the insertion of the code (3) and the equipment will only accept codes of workplaces of class (5).

Class of external workplaces (4): these codes are individual codes for each apiary and each existent apiary must receive an unique number; the reading of the code of an apiary, followed by the reading of code (7) of a bee family (FA) means to the system that this family has been inserted in this apiary at this moment; when in external work and the team has already taken the expedition material and read its code (P13) the equipment (HW) will only accept codes of classes 4, 6 (all but 6.2.1), 7, 8, 9, 10, 11; every material or tool arriving at this local will be in provenance from the expedition deposit (5.2.1), from another family (7), from another apiary (4); every material or tool going out from this local must go to one or more of the receptions (5.2.2; 5.3.1.1; 5.3.2.1; 5.3.3.1; 5.3.4.1; 5.3.5.1; 5.3.6.1), to another family (7) or another apiary (4);

Note:

For the internal workplaces, a different version of the equipment HW could be used, with a code reader attached to the equipment.

Class of internal workplaces (5): in an internal job, the employee could work in three types of workplaces:

Subclass of administrative department (5.1): Activities of the local administration:
(5.1L) to decide how to orient the employees in sections (5.3.1.2; 5.3.2.3; 5.3.3.3; 5.3.4.3; 5.3.5.1; 5.3.6.3) about the criteria and procedures for possible lot mixing, when they follow a way out of these sections; the administration can standardize the adopted procedures (example: all with the same color may be mixed, all honey of the same flowery may be mixed, etc) and this must be informed to the system, in such a manner that when an employee of this section is in the final task and he needs that information (P10), the system will inform him automatically about the procedure to be adopted; even if the department adopts fixed procedures per products, at any time, the production manager can change the information in the system and this information will arrive to the employee by (P10);
(5.1C) to generate and control the generation of identification codes, following the describe procedure (P7) and occasionally, when convenient for the company, generate and control what is described in (P8)
(5.1R) to opt and orient the receptionist (5.3.1.1; 5.3.2.1; 5.3.3.1; 5.3.4.1; 5.3.5.1; 5.3.6.1) about the criterion (P9) adopted for tracing products arrive from the field, when they arrive in the reception for improvement:
1—to standardize per product (honey, propolis, etc) a single criterion for tracing it—so when this product arrives in the reception, the system automatically orients to the option chosen by the administration and the administration no longer needs to worry about this point; when choosing this option the administrator still have the possibility to eventually change the tracing criterion for a special lot; for such change it is sufficient to orient the system and the receptionist will receive the information automatically;

2—not to standardize the criterion for tracing the product—so the information of product arrival in the reception (by the reading of the code of the entrance sub-area in the reception of products for improvement, performed by the deliverer when he put there the product) must arrive directly to the administrator who will then opt by the tracing criterion for that lot, and inform it to the system; the receptionist will receive the information automatically;

Subclass of storing and conditioning of materials department (5.2): it will have the following codes per work section:

Subclass of expedition materials storing (5.2.1): area destined for stored materials which are available to be taken; the place must be subdivided in areas as described in (P11); after the external job (in which the use of a stored material or tool is expected) has been booked, the system must list and book (P10), to the internal personnel, all the materials that must be taken from the storage and put in this section (in a sub-area chosen by the system), waiting for being used in this task; the materials must be taken from the warehouse by procedures (P3) or (P5), so the external personnel (1) can take them (by P10) for use in the field, following procedure (P13); every material or tool that arrives to this section, usually comes from the warehouse (5.2.6) and sporadically comes from other sections in this department (5.2); every material or tool that leaves this section goes to the apiaries (4), or goes out of the company (example: repairing, lending, etc); internally and sporadically in this department (5.2) this section may send materials or tools to every other section (5.2) or back to the warehouse (5.2.6);

Subclass of reception, sorting and cleaning for the materials storage (5.2.2): this place must be subdivided in areas by (P12); it is destined to receive (entrance sub-areas) materials coming back from the field (4), from improvement receptions (5.3.1.1; 5.3.2.1; 5.3.3.1; 5.3.4.1; 5.3.5.1; 5.3.6.1) or from acquisition; when it is an acquired material, an invoice is obligatory, and it must be sent to the administration (5.1C) after supervised by the receptionist, so the administration can proceed as determined by (P7) and send the identification for this section; when such codes are in expedition with the material, the material can already be sent to the identification section (5.2.3) following procedure (P3) or (P5); the external personnel must leave all the material carried in the identified place (entrance sub-area), which has been previously booked by the system; such material must be sorted, selected or, if necessary, cleaned, so it can be sent to the warehouse or to other sections inside the department, and be prepared to be stored; when materials with damaged code are found during sorting, they must be separated, and the administration (5.1C) must be informed; when it is the case (optional) the pyrographic (P8) number must be informed; the administration must print the new code following (P7) and send it to the expedition; only from this point on the material will be available to be taken to the identified section (5.2.3); about the material cleaning, when it implies propolis or wax cleaning, the material must be taken to an appropriate place (5.3.5.1 and 5.3.6.1) following procedures (P3) or (P5); every material found in this place (5.2.2) must be supervised (by the internal personnel), to verify if they are in accord or not with the standards required for storing this product; based on this verification, the materials can be sent to specific sections (example: painting, wax insertion, etc), to be repaired or conditioned to storage (5.2.6); the only material that can be accepted to be directly stored with no sorting (if it is a recommendation of the establishment manager), is the material that went to the field and was not used; every other material must pass the sorting, and must then be grouped, being place in different areas of exit places, depending on the destination; this changing process may be repeated, by taking a material from a section to another, until the storing of materials in the warehouse (5.2.6) is finished; a simple code reading, one followed by the other, makes clear for the system the path followed by the material, and its intermediary or final destination; when the material comes back from the field and is left by the external personnel (1) in this reception, the personnel must read the code of the sub-area as described in (P13); every material that leaves this section may have as destiny any other section in this department (codes 5.2); or it can go to the sections of cleaning propolis or wax (5.3.5.1 and 5.3.6.1); they must come back to this section and all of them must finally go to the warehouse (5.2.6), excepting the materials that may go out for repairing, lending and etc. the material goes directly to the expedition (5.2.1)

Subclass of place for identification, assembling and maintenance in the materials storage (5.2.3): every material recently acquired, available in the reception (5.2.2) must come to this place following (P3) or (P5) with identification labels generated by the administration (5.1C), as in (P7), for affixing codes to the material and mark (pyrographic) the material, if the company has opted to identify individually its material; in case of material with damaged identification label available in the reception (5.2.2), it must be sent to this place by (P3) or (P5) with the new labels generated by the administration (5.1C) according to (P7), for a new code affixing; reading the code of this section, followed by the new code indicates to the system that the code has been affixed at this moment; since this place is also used for exchanging pieces of materials in use, reading the code of this place, followed by the code of a material in use, means that the material has been repaired at this date; every recently acquired material has obligatorily come from the reception (5.2.2) to this place, but materials in use that arrive to this section may come from other sections of this department; every material going out of this section may go to any other section of this department;

Subclass of place for frame wiring and wax fixing (5.2.4): this place will only accept the entrance of wire rolls, wax packs and hive frames, based on (P3) or (P5); the wax and the wire must come from the warehouse (5.2.8) to this place; reading the code of a wire roll or the code of a wax pack, followed by the reading of codes of hive frames, will have a meaning to the system based on procedures (P6) independent of reading the code of this section; every material arriving to this section may come from every section of this department (5.2); every material going out from this section may come from every section of this department (5.2);

Subclass of place for materials painting (5.2.5): this place is destined to the painting of materials of external use, like: parts of the beehive, harvesting tools, etc; reading the code of the material to be painted, after having read the code of this place and the codes of the painting supplies, will have a meaning to the system based on procedures (P6); every material arriving to this section may come from every section of this department (5.2); every material going out from this section may come from every section of this department (5.2);

Subclass of place for storing materials in the warehouse (5.2.6): place destined to store every material and tool used by the jobs in the field; reading the code of any material after the reading of this code will mean to the system that the material has been stored at this date; this place, like the reception and the expedition, must have subdivisions like (P11) and every type of material must have an appropriate area to be stored; every material or tool stored in this place must have passed by the materials reception (5.2.2), when arriving, and must pass by the expedition (5.2.1), when going out; every material arriving to this section may come from every section of this department (5.2); every material going out from this section must be sent directly to the expedition (5.2.1), if it is a non conforming material, it may be sent to any other section of this department (5.2);

Subclass of place for storing hive frames (5.2.6.1);

Subclass of place for storing covers (5.2.6.2); etc;

Subclass of feed preparation place (5.2.7): this place is destined to the preparation of feed to be given to the bees during the period between harvests; reading this code, followed by the code of any material destined to feeding bees, will mean to the system that the material has been used at this date to prepare feed; after prepared and if necessary, the feed may be stored in the warehouse; every material arriving to this section must come from the warehouse (5.2.8) and from the expedition; every material going out from this section may go to the field (4, 7) or to the warehouse (5.2.6), passing by the reception (5.2.2);

Subclass of warehouse (5.2.8): in this place, all the supplies to be used in the internal and external activities must be stored; the invoice of each supply that arrives in the reception must be sent to the administration (5.1C), who shall enter the invoice in the system and emit identification codes (P7), then send them to the reception, which will let available the invoice to be taken to the warehouse, by procedures (P3) or (P5); every invoice arriving in this section must come from the reception, and every invoice going out from this section must go to a vehicle (3) or to the sections (5.2 and 5.3) of this department;

Class of product improvement (5.3):

Subclass of section destined to the reception of honey (5.3.1.1): this place must contain subdivisions as described by (P12) and when a product (still in honeycombs, before centrifugation) coming from the field is left (by the external personnel) in this place (entrance sub-area), the external personnel must just read the code of the sub-area where he is leaving the material (P13); the internal personnel (product improvement area), when initializing the reception activity, must first consult its traceability equipment (HW) about the orientation (5.1R) of how to proceed (P9) for tracing this product (the system is aware of the existence of a product in the reception, due to the codes read by the deliverer); afterwards he must proceed to the selection following the orientation received (P10) and (P9) and transfer the product to the subdivisions of exit to expedition; this section only receives materials containing products coming from the field (4) and sends the honey (with no preparation) to the sections of uncapping and centrifugation;

Subclass of place destined to the uncapping and centrifugation (5.3.1.2): the internal employee (product improvement area), before starting the job of uncapping and centrifugation, must collect the already selected honeycombs (from the hive frames) (P9) deposed in the reception (5.3.1.1) in the exit sub-areas, in accord with (P3) and (P5); he must transport the combs to this place by reading the code of this place or by reading the code of the equipment that will receive the product for improvement; when finished the centrifugation, the material goes to external cleaning (washing with a water micro-jet and drying, or cleaning by the own bees, to remove honey residues); after an operation of external cleaning, the material goes back to the sorting place in the warehouse and so it follows its way; in the uncapping and centrifugation place, the honey waits until being led to decantation tanks;

Subclass of decantation tanks and honey filtration (5.3.1.3): after centrifugation, the honey must be pumped or transported to the filtration and decantation tanks; at this moment, the operator must chose the tank; he does it by the equipment menu or reading the code of the tank that will receive the product, followed by the code of the place (or equipment) from where the centrifuged product is coming; this means to the traceability equipment that the product that was just centrifuged has been stored in this tank; from now on, the honey in traced (in the production establishment) decantation tanks, may follow one of the following three ways:

Subclass of mixed honey (5.3.1.4): to follow this way, the operator must read the code of a decantation tank containing honey, followed by the code of another decantation tank also containing honey or, directly in the menu, choose two decantation tanks containing honey and click over both; by one manner or the another, the traceability equipment must open fields on the screen, to ask for the quantity of honey from each tank will be used by the mixing; afterwards, the honey must be sent to the homogenizer and then the product can follow one of the following two ways:

Subclass of storing tanks (5.3.1.5): honey may arrive to storing tanks coming directly from decantation tanks or coming from the homogenizer; the operator must read (or choose in the menu) the code of the storing tank which will receive the product, followed by the code (or menu choice) of the decantation tank or homogenizer from where the honey is coming; it will mean to the equipment that the product has been transferred to this place; if honey needs to by transferred from a tank to another, the operator must read the code of the source tank, followed by the code of the target tank, and the equipment will understand that the product has been transferred;

Subclass of bulk packing or fractioning for retailing (5.3.1.6): each package size must have a sub-code in order to make easy the counting of the total volume taken from the source recipient; to perform traceability in this step, the operator reads the code of the source recipient and then reads the codes of the receptors recipients (P3*), and the equipment will transfer the information about that product to this code; if the product is placed in bulk package, the cycle may be reproduced in the receptor industry, if it has adopted this system for traceability control; even if the receptor industry does not adopt this system, it can access all the information about that lot in a WEB site specially developed for this purpose, based on the codes of the packages; the same is valid for fractioned bottles in retailers, which carry a registered number after quitting the industry, and the number can be accessed by the consumer in a WEB environment;

Subclass of area for storing honey ready for sale (5.3.1.7): as cited before, this place must also be subdivided in accordance with (P11), and a product must be transferred to this place following (P3) or (P5); the product must be transported to this place according to the orientation of the system, indicated in the HW; this product from now on will be available at this place until being taken.

Subclass of area for pollen reception (5.3.2.1): this place must contain subdivisions according to (P12) and when the pollen recipients in provenience from the field (4) are deposed in this place (entrance sub-area) by external personnel, according to (P13), the internal employee (product improvement area), according to (5.1R and P10), must separate this product according to (P9) and from this moment on the product will be available to be taken to processing (5.3.2.2);

Subclass of equipment for pollen drying (5.3.2.2): to start this process, the internal employee must get the product in the reception (exit sub-area) and take it to the cleaning and drying section according to (P3) or (P5); in such manner the system will understand that the product is in the equipment, ready to be processed (the equipment must be electronically monitored and automatically transfer the information to the traceability system); after finished the operation, the product will be available to be taken to the packing place (5.3.2.3).

Subclass of area for packing pollen (5.3.2.3): the product must be transported from (5.3.2.2) to (5.3.2.3) according to (P3) or (P5); the employee of this section must take the product, pack it and make it available in the exit sub-area of this section; at this moment, the product will be ready to be collected and taken to the final products storage (5.3.2.5); during the packing process, the conditions of humidity and temperature must be electronically monitored and automatically informed to the system;

Subclass of packages for bulk pollen or fractioned bottles for retailing (5.3.2.4): the packages must receive sub-codes, according to the quantity of product carried, to make easy the calculation of the quantity of traced product; from this moment on, bulk packages and fractioned bottles must have an identification code that can be consulted in a WEB environment, able to give information about the product to industrial or final consumer;

Subclass of area for deposit of this final product—ready for sale (5.3.2.5): after being bulk packed or fractioned, the product must go (P3 or P5) to the deposit which will be subdivided according to (P11), where it must stay until sold and sent to the buyer; in this place the information about temperature and humidity must be electronically monitored and automatically informed to the traceability system;

Subclass of area for poison reception (5.3.3.1): the place must be subdivided according to (P12) and the product must be deposed according to (P10 or P13) so the internal employee of this sector can select it (P10 and P9); the environments for this product must have electronically monitored temperature and humidity, and the results must be automatically informed to the system; this section receives materials with product in provenance from the field (4) and send to (5.3.3.2);

Subclass of equipment for poison drying and processing (5.3.3.2): the product must be transported according to (P3) or (P5) directly to the place or equipment for drying and processing; from this moment on its operational conditions must be monitored and the monitored data must be automatically sent to the traceability system; this section receives materials with product in provenance from (5.3.3.1) and send to (5.3.3.3);

Subclass of area for poison packing (5.3.3.3): this section (according to P12) receives a product from (5.3.3.2) and sends to (5.3.3.5) in accordance with (P3) or (P5); during the packing process, the humidity and temperature conditions must be electronically monitored and automatically informed to the system;

Subclass of package for poison (5.3.3.4): idem to item 5.3.2.4;

Subclass of storage for packed poison, ready for sale (5.3.3.5): idem to item 5.3.2.5;

Subclass of area for royal jelly reception (5.3.4.1): procedure identical to the pollen;

Subclass of area for extraction and filtering of royal jelly (5.3.4.2): the product must arrive in this section according to (P3) or (P5), by performing reading in place or in the suction pumps;

Subclass of area for royal jelly packing (5.3.4.3): process and procedures identical to the same item for pollen;

Subclass of packages for conditioning royal jelly (5.3.4.4): process and procedures identical to the same item for pollen;

Subclass of place for the reception of propolis or material containing propolis (5.3.5.1): idem (5.3.3.1);

Subclass of place for scratching materials for collecting propolis (5.3.5.1.1): the product must be transported according to (P3) or (P5) from (5.3.3.1) to this place, so it can be scratched and removed from the material; after finishing this operation, the product of the scratching must be made available isolated from the materials, in recipients (vehicles) for internal transport and in the exit sub-area (5.3.5.1.1.2) and the materials must go back to the reception for sorting and cleaning (5.2.1) for other conditioning, if necessary;

Subclass of place or equipment for weighting, cleaning, selection and packing propolis (5.3.5.2): to this place, the products must arrive from section (5.3.5.1 or 5.3.5.1.1) by (P3) or (P5) and must be deposed at the entrance sub-area; when being taken from that sub-area by the personnel of this section, the total weight of the product must be measured, and only after this measurement may be proceeded the cleaning and selection of the lot; afterwards, each lot resulted from selection must be weighted, and the sum of the weights of selected lots plus the removed residues must equal the total weight measured in the beginning; these lots may be mixed to other lots of the same type of selection (color and size) while keeping traceability; when the process of “initial weighting, cleaning, selection and final weighting” (of the lots resultant of this procedure) is executed by an automatic equipment, reading the code of the recipient containing the lot, by the code reader of the equipment, followed by a weighting, will indicate to the system (traceability system) that this is the total weigh of the lot; afterwards, the equipment system itself will indicate (to the traceability system), the amount in weight, of each sub-lot selected per size or color; when the process of “initial weighting, cleaning, selection and final weighting” is performed manually, the employee must weight the lot and, with his HW, perform the reading of the code of this place, followed by the read of the code of the lot recipient; in this case, the system will open a space on the equipment screen for the employee to enter the weight measured; then the employee can select the product by size or color, and finally it must read again the package code (with a specific code for each color or size); the system will open a space on the equipment screen for the employee to enter the weight measured for the sub-lot; the employee of this section must have standardized information (via HW) coming from the administration (5.1) about the procedure that he must adopt with respect to mixing sub-lots, of the same type (color and size) but from different origins; at the end of the selection and cleaning of each lot, the sum of the weights measured for each lot must be equal to the weight measured by the initial lot; however, every lot must be placed in heavy and coded packages, not depending on if the lot is mixed or not; then, the packages must be sealed and made available at the exit area of this section, so it can be sent to (5.3.5.4);

Subclass of package for propolis (5.3.5.3): the packages for propolis must have specific codes for this product; all the information in provenance from the type selected (size or color) or pre-selected (per family, apiary or region) and all other traceability information must be in the system, linked to the specific code of each package;

Note: every traced product, when sold in wholesales or in retailers, carries with itself an identification code, which allows the buyer to obtain all the information about such product via Internet in a specific environment.

Subclass of place for storing gross propolis packed and ready for sale (5.3.5.4): the product correctly packed and coded must leave the section (5.3.5.2) by (P3) or (P5) and come to this section; this section can be divided according to (P11); in this place the product is ready to be sold in bulk, and the history of its traceability is available in the system; in this place the product may be taken to the tanks for extracting ink;

Subclass of place for the reception of wax or material containing wax (5.3.6.1): the procedures will be equal to the previous; after a cleaning of this section, the materials must follow their way up to the final warehouse, according with has been programmed by the reception;

Class of products in use (6);

Subclass of supplies (6.1):

Example: packages of laminate wax (6.1.1): the reading of this code may be preceded by the reading of the code of the warehouse (5.2.8), meaning to the applicative software (SW) that this recently acquired material has been stored in this section; the reading of this code may also be preceded by the reading of the code of the place for fixing wax (5.2.4), meaning to the system that this wax pack will be used in this place for fixing frames; the reading of this code may be followed by the reading of hive frames, meaning to the system that laminate wax from this package has been put in this hive frame;

Subclass of medicines (6.2): the reading of the code of the applied medicine, preceded by the reading of the code of a bee family unit (FA), will mean to the system that this medicine has been applied to this bee family unit (FA); this operation may be repeated many times, meaning to the system that there are as many infected families as the number of family codes associated to this package;

Subclass of consumables (6.3)

Class of beehives of bee families (7): reading the bee family units (FA) in an apiary booked for work, will mean to the system that this worker's team has worked on this family at this moment, independent if the apiary code has been read (with validation by GPS); if the reading is not in the booked bee family units (FA), then he will consider as additional job, and will modify the route for the work originally traced; if two worker teams (due to a mistake) work in different times in the same FA, the applicative software (SW) after transferring data to the computer of the operational central (C), this (SWG) will consider and register the two jobs, in the chronological order they have been executed, independent of the chronological order of inserting data in the central system (central computer);

Note:

bee families must be interpreted as a production unit, containing a mean volume of 5 liters of female stereo bees, with a queen, correctly installed in wood boxes ((ex: Cx1; Cx2 and Cx3), as illustrated in FIG. 3.

Class of apicultural materials (8): when in the field, all these materials must be in provenance from the expedition (5.2.1) and when returning from field or apiaries (4), they must go back to the receptions of the departments (5.2 or 5.3); so, reading this code will be valid for the system when preceded by the readings of code of sections in the departments (5.2 and 5.3) meaning that they are in this section; this code will also be valid for the system when preceded by the readings of code of families (7), meaning that they are now part of the family; when the materials are removed from apiaries (4) or from families (7) the reading of its code is not performed; it will only be performed in arrival, in receptions (5.2 and 5.3) meaning to the system that it has been removed from the family; in this case we can it is sufficient to read the codes of material which eventually is entering to replace what is being removed, and this will mean that this new material if part of this family (P7);

Subclass of hive frames (8.1)

Subclass of hive tops (8.2)

Subclass of bottom boards (8.3)

Subclass of supports (8.4)

Subclass of covers (8.5)

Subclass of boxes (8.6)

Subclass of boxes of honeycombs (8.7)

Subclass of propolis collectors (8.8);

Subclass of poison collectors (8.9);

Subclass of pollen collectors (8.10);

Subclass of excluding frames collectors (8.11);

Subclass of feeder collectors (8.12);

Subclass of royal jelly production (8.13);

Subclass of queen production bars (8.14): the reading of this code, preceded by the reading of the code of a family (FA) or a hive frame, means to the system that the queens who will born in this bar are descendant of the queen of this family or the family that contains that hive frame;

Subclass of drawer for pollen collection (8.15);

Subclass of poison collector lamina (8.16);

Subclass of jail for queen birth (8.17): the reading of these jails preceded (P3*) by the reading of a queen birth bar, means to the system that the queens that will birth in these jails are daughters of the queen used for donating larvae for the execution of grafting (activity that use larvae, of a maximum of three days from arising, to introduce manual and individually in each of the jails for queen birth) in that bar; the reading of these jails preceded by the reading of a bee family unit (FA), will mean to the system that at this date, jails were introduced in this bee families units (FA) for the birth of queens. This means that they will be available from their birth on to be introduced in other families or for sale;

Subclass of queen transport and introduction jail (8.18): the reading of the code of an introduction jail followed by (or vice-versa) the reading of the code of a jail for queen birth, will mean to the system that the queen has been transferred to this jail; the reading of one of these jails preceded by the reading of a bee family unit (FA), will mean to the system that the queen is being introduced in this bee family unit (FA) and replacing the previously present queen, if it exists;

Procedure for donating younglets, feed or other material from a family to another: the reading of the code of a bee family (FA) followed by the reading of the code of a hive frame which was already in another bee family (FA) will mean to the system that this hive frame from now on is part of this other family; the reading of the code of any material appertaining to a bee family, preceded by the reading of the code of other family, also will mean to the system that this material from now on is part of this new family;

Subclass of transport frame (8.19): the reading of the code of a bee family unit (FA) followed by the reading of the code of a transport frame, will mean to the system that this material is part of this family from now on;

Procedure for the transport: the reading of the code of an apiary, followed by the code of bee family units (FA) being transported, will mean to the system that these families are part of this apiary from now on, independent of having transport frames (validate by GPS);

Class of tools and equipments (9):

Subclass of transport tools (9.1):

Subclass of vehicles for internal transport (9.1.1): they are used for moving materials inside the warehouse (5.2) or in the place for product improvement (5.3); this small vehicles must contain subdivisions, marked with ink, with different sub-codes (ex: 6.1.1.1; 6.1.1.2), useful for linking codes of several materials to a sub-area of the vehicle for a certain destiny and afterwards do the same operation in another sub-area of the same vehicle to another destiny, meaning to the system that materials of different origins may be collected and distributed together to several destiny places; the other functionality of the small vehicle is that when it arrives to the destiny (a place), it is sufficient to read its code, followed by the code of the sub-area of the vehicle where the content is placed; this will mean to the system that, every material read one by one and linked to the small vehicle is now at this place, without needing to read individually the codes; this tool aims to avoid unnecessary reading of material codes, one after the other, in a delivery;

Subclass of external transport vehicles (9.1.2): they are used for the transport of external materials and they do not need to be subdivided, since they have no defined importance for traceability, but only operational usefulness;

Subclass of wax transport recipient (9.1.3): the reading of the code of the wax transport recipient, preceded (P3*) by the reading of the code of a bee family unit (FA), means to the system that this material has been scratched in the field and collected from this bee family unit (FA); repeating this operation many times will mean to the system that the collected material is in provenance from all the families, as many as the number of family codes read, and that they are now linked to this recipient;

Subclass of propolis transport recipient (9.1.4): procedure identical to that for wax;

Subclass of pollen transport recipient (9.1.5): the reading of the code of the pollen transport recipient, preceded by the reading of the code of a bee family unit (FA) or the code of the pollen collector or collection drawer, will mean to the system that this material has been collected from this bee family unit (FA); repeating this operation many times, will mean to the system that the collected material is in provenance from all the families whose code has been read and linked to this recipient;

Subclass of poison transport recipient (9.1.6): the reading of the code of the poison transport recipient, preceded by the reading of the code of a bee family unit (FA) that contains a poison collector or the code of a poison collector or poison collection lamina, will mean to the system that this material has been collected from this bee family unit (FA); repeating this operation many times, will mean to the system that the collected material is in provenance from all the families whose code has been read and linked to this recipient;

Subclass of bee feed transport recipient (9.1.7): the reading of a recipient with feed, preceded by the reading of a bee family unit (FA) indicates that this FA has been fed at this date;

Subclass of brush-cutter (9.2): the simple reading of the code of an apiary or any of the bee families (FA) contained in it, followed by the reading of the code of a brush-cutter, will mean to the system that this apiary has been cleaned at this moment;

Subclass of smokers (9.3): this and other small tools must be in the materials expedition content, with other material booked to be taken to the field;

Class of illness (10): the reading of a code of this illness or the selection of this illness on the traceability equipments (A) screen, preceded by the reading of a code of a bee family unit (FA), will mean to the system that this bee family unit (FA) is infected by this illness; repeating this operation many times, will mean to the system that the there are as many infected families as the number of families whose codes have been read and linked to this illness;

Procedure for terminating the operation in an apiary or in a family: the reading of the code of a bee family unit (FA) followed by the code of another bee family unit (FA), will mean to the system that the box has been opened, revised, but did not need anything; the reading of the code of an apiary (verified by the GPS) not followed by the reading of the code of any operation, will mean to the system that the apiary has been visited and that only an external inspection has been done; the reading of the code of an apiary followed by the reading of materials or families (FA) previously installed in this apiary, will have no meaning to the system, since the sign that marks the beginning of the job in an apiary is the reading of the code of a family; the operator does not need to read the code of the apiary in the final of the journey, to indicate job finished; the system will note this event, by the movement of the GPS coordinates and by eventual reading of families in other apiaries; the reading of the code of a family (FA) followed by the code of another, or by the reading of other codes that indicate procedures in the first family, and followed by the code of the other family, indicates to the system that the job in the first family is finished and a job has started in the second family;

Procedure for work journey finishing (19): after finishing the job in the field, the empty material left in the materials reception and the material containing products left in the product reception, the leader of this team must pass his identification cards indicating to the applicative software (SW) that his part of the job is finished; the leader must indicate the card, and the hardware (HW) will turn off automatically and can be put on its base; if the hardware (HW) is left in its base without being identified the operator's card (1) and automatically turned off, the equipment will emit the same sound and/or light alarms cited before, until the cited procedure is executed;

Class of theft or damaging of bee family units of materials (11): this code may be read or searched in the hardware (HW) operation menu, to communicate the system that something has been theft from the apiaries; when its reading (or menu searching) is preceded by the reading of a bee family unit (FA) it will mean to the system the something has been theft from this bee hive; when the theft in the beehive is of any unit material (unit in the sense that the beehive has only one) appertaining to the beehive, the operator will need to, after the previous procedure, choose the code (of the theft material) in the equipment menu and select it, indicating to the system that the theft material is this one; when the theft is of hive frames of boxes, the operation is the same, but the code of the material will not need to be searched in the menu; the simple reading of the remaining boxes and hive frames will indicate to the system that the others have been theft; when the theft if not only of material but also of bee families (FA) the choice of theft codes in the equipment menu must be preceded by the reading of the code of the apiary, and if a family (FA) remains, its code must be read to indicate to the system who has been theft; if after reading the code of an apiary, followed by the reading of the code of theft, no family code is read, it will mean that all families have been theft;

Based on what has been described and illustrated, one can notice that the “TRACEABILITY SYSTEM APPLIED TO FARM PRODUCTION ACTIVITIES, INDUSTRIALIZATION AND COMMERCIALIZATION OF BEE PRODUCTS” here claimed is in accordance to the norms and requirements for international patenting, as disposed by the Patent Cooperation Treaty (PCT), and it deserves the claimed privilege.

1. “Traceability system applied to farm production activities, industrialization and commercialization of bee products”, whose functional architecture is characterized by containing a traceability specific electronic equipment (A), a management software (SWG), a special protective clothing (B), a data acquisition process (PAD) based on classes and sub-classes of identification codes (that can be used Bar Code or RFID as identification technology), a specific logistic process (PL) for storage and transference (internal or external) of beehives, materials, products and merchandise, a security system (SS) and wireless communication system (CW).

2. “Traceability system applied to farm production activities, industrialization and commercialization of bee products”, according with the claim 1, characterized by containing a traceability specific electronic equipment (A) made up of one hardware (HW) which possesses, amongst other components, one Global Positioning System (GPS) module, digital display, memory for storage of collected information, bar code or RFID reader module, wireless communication equipment for long distances, integrated circuit and processor, all of them managed by a firmware, a software that is embedded in the hardware device.

3. “Traceability system applied to farm production activities, industrialization and commercialization of bee products”, according with claim 1, characterized by the fact that the electronic device to traceability (A) is not taken in hands, but it is tied up at the beekeeper's body, a digital display also tied up at his forearm and a reader of bar code fixed at the back hand (at the same arm of the digital display) fixed at the glove (B1) of the special protective clothing (B) and the communication of all of this components could be by wireless or not.

4. “Traceability system applied to farm production activities, industrialization and commercialization of bee products”, according with claim 1, characterized by the bar code reader (LCB or RFID) of the device (A) to be started through another electronic device, fixed at the same glove where is fixed the bar code reader.

5. “Traceability system applied to farm production activities, industrialization and commercialization of bee products”, according with claim 1, characterized by the electronic device (A3), which is used to activate the bar code reader, to be compounded by two little metallic plates, both installed at the same glove, one at the index finger and the other at the thumb. Therefore, to turn on the code reader, the operator moves his fingers to put both metallic plates in contact.

6. “Traceability system applied to farm production activities, industrialization and commercialization of bee products”, according with the claim 1, characterized by being necessary only one hand to operate the equipment for reading the RFID or bar code labels. The operator needs only to point his arm (which carries the code reader) to the label and use the fingers of the same hand to press the button (A3) and activate the code reader.

7. “Traceability system applied to farm production activities, industrialization and commercialization of bee products”, according with claim 1, characterized by the traceability equipment (A), when not in use, to be connected and over a base (A1), which is installed in the operational management room (C) and is connected to a computer having the management software (SWG) installed.

8. “Traceability system applied to farm production activities, industrialization and commercialization of bee products”, according with the claim 1, characterized by having a management software (SWG) installed on the computer at the management room (C) to receive data from all traceability equipments (A), to process such data and make them available on screen or on paper, in a report format, to all workstations connected to this computer. Short information is presented on the display of the traceability equipments (A), always according to access authorization.

9. “Traceability system applied to farm production activities, industrialization and commercialization of bee products”, according with the claim 1, characterized by the special protective clothing (B) to have gloves with glue (or other product for fixation), on the back hand, for fixing the code reader, and at the cuff, for fixing a digital display. The special protective clothing to have special covering to protect the wires, when the components of the equipment (A) will not be wireless, pockets made by impermeable material to protect the equipment (A). The special protective clothing to have speakers and microphone at the hat, to communication between the beekeepers of the same team.

10. “Traceability system applied to farm production activities, industrialization and commercialization of bee products”, according with the claim 1, characterized by having a data acquisition process (PAD) that determines that all products, persons, vehicles, materials, tools, equipments, rooms, hives must be identified with bar codes or RFID labels, ordered in classes and sub-classes.

11. “Traceability system applied to farm production activities, industrialization and commercialization of bee products”, according with claim 1, characterized by data acquisition process (PAD) to follow a functional logic based on sequences of classes and subclasses of codes (LCB or RFID) wherein The classes of codes are: employee that operates the equipment (1); other employees (2); vehicles (3); apiaries (4); internal workplaces (5); 5 supplies, consumables and medicines (6); beehives or bee families (7); hive materials (8); tools and equipments (9); diseases (10); theft or damage of hives or materials (11).

12. “Traceability system applied to farm production activities, industrialization and commercialization of bee products”, according with claim 1, characterized by the data acquisition process (PAD) to contain a class (1) of the employees that operate the equipments (A) as a unique class able to start de equipment (A) and than operate this equipment during the working day.

13. “Traceability system applied to farm production activities, industrialization and commercialization of bee products”, according with claim 1, characterized by the data acquisition process (PAD) to contain a class (2) of the other employees that do not operate the equipments (A).

14. “Traceability system applied to farm production activities, industrialization and commercialization of bee products”, according with claim 1, characterized by the data acquisition process (PAD) to contain a class (3) that represents all vehicles used to work.

15. “Traceability system applied to farm production activities, industrialization and commercialization of bee products”, according with claim 1, characterized by the data acquisition process (PAD) to contain a class (4) that represents all apiaries, whose GPS coordinates must be registered and where the beehives are located for production.

16. “Traceability system applied to farm production activities, industrialization and commercialization of bee products”, according with claim 1, characterized by the data process acquisition (PAD) to contain a class (5) that represents all departments to keep or process products (internal workplaces), and such departments are subdivided as follows: management department (5.1), department to store materials (5.2) department to process products from the farm (5.3).

17. “Traceability system applied to farm production activities, industrialization and commercialization of bee products”, according with claim 1, with the additional feature that in the data acquisition process (PAD), the subclass of code (5.2) is characterized by the following sequence of subclasses: code of expedition of the materials warehouse (5.2.1); Code of reception, selection and cleanness of the materials warehouse (5.2.2), Code of the identification place, assembly and exchange of parts of the materials warehouse (5.2.3) Code of place for introduction of wire and wax setting (5.2.4) Code of the materials painting place (5.2.5) Code of the place for storage of materials in the warehouse (5.2.6); Code of the place for food preparation (5.2.7) and code of the warehouse (5.2.8).

18. “Traceability system applied to farm production activities, industrialization and commercialization of bee products”, according with claim 1, with the additional feature that in the process of data acquisition (PAD) the subclass of codes (5.3) is characterized by the following sequence of subclasses: code of the honey improvement area (5.3.1); code of the pollen improvement area (5.3.2); code of the poison improvement area (5.3.3); code of the real jelly improvement area (5.3.4) code of the propolis improvement area (5.3.5) and code of the bee wax improvement area (5.3.6).

19. “Traceability system applied to farm production activities, industrialization and commercialization of bee products”, according with claim 1, with the additional feature that in the process of data acquisition (PAD) the subclasses of codes (5.3.1 to 5.3.6) are characterized by containing sections for improvement of products, which are reception, expedition, deposit of finished products and specific sections for improvement of each product, having all these specific subclasses of codes, which will not be described specifically in this document.

20. “Traceability system applied to farm production activities, industrialization and commercialization of bee products”, according with claim 1, with the additional feature that in the process of data acquisition (PAD) the subclass of codes (6) of supply, consumable and medicines, is characterized by the following subclasses: codes of supplies (6.1); codes of medicines (6.2); and codes of consumable (6.3).

21. “Traceability system applied to farm production activities, industrialization and commercialization of bee products”, according claim 1, with the additional feature that in the process of data acquisition (PAD) the subclass of codes (7) is characterized by being represented by beehives or bee families that must be installed in the apiaries (4).

22. “Traceability system applied to farm production activities, industrialization and commercialization of bee products”, according with claim 1, with the additional feature that in the process of data acquisition (PAD) the subclass of codes (8) of apicultural materials, is characterized by the following subclasses of codes:
Codes of hive frames (8.1); Codes of covers (8.2); Codes of bottom board (8.3); codes of hive support (8.4); Codes of coverings (8.5); Codes of boxes of nest (8.6); Codes of boxes (8.7); Codes of propolis collectors (8.8); Codes of poison collectors (8.9); Codes of pollen collectors (8.10); Codes of queen excluder (8.11); Codes of feeders (8.12); codes of jelly production (8.13): codes of queen production (8.14): Codes of drawers for pollen collectors (8.15); Codes collecting blade poison (8.16); Codes of queen birth jails (8.17); Codes of jails for transport and introduction of queens (8.18): Codes of transport screens (8.19).

23. “Traceability system applied to farm production activities, industrialization and commercialization of bee products”, according with claim 1, with the additional feature that in the process of data acquisition (PAD) the subclass of codes (9) of tools and equipment is characterized by subclasses identifying them for type, model and individually.

24. “Traceability system applied to farm production activities, industrialization and commercialization of bee products”, according with claim 1, with the additional feature that, in the data acquisition process (PAD) the sub-class of codes (10) of bee diseases is characterized by identifying each disease by a code of this class.

25. “Traceability system applied to farm production activities, industrialization and commercialization of bee products”, according with claim 1, characterized by the data acquisition process (PAD) to contain in the class of codes (11) of theft or damage of bee families or materials, the following subclasses: theft (11.1) or damage (11.2).

26. “Traceability system applied to farm production activities, industrialization and commercialization of bee products”, according with claim 1, with the additional feature that the data acquisition process (PAD) is exclusively executed and fed with data by the traceability equipment (A) through subsequent readings of RFID or bar codes (LCB) ordered as classes and subclasses.

27. “Traceability system applied to farm production activities, industrialization and commercialization of bee products”, according with claim 1, characterized by having each activity in the data acquisition process (PAD) executed with the traceability equipment (A) and registered through the reading of a unitary set or a set of a pair of RFID or bar codes (LCB), where each set has a unique interpretation or meaning in the process.

28. “Traceability system applied to farm production activities, industrialization and commercialization of bee products”, according with claim 1, characterized by the fact that in the data acquisition process (PAD) the readings of unitary sets of codes indicate to the system the beginning of an activity.

29. “Traceability system applied to farm production activities, industrialization and commercialization of bee products”, according with claim 1, characterized by contain a data acquisition process (PAD) that, when it executes the readings of sets of pairs of codes, this indicates to the system that a material was integrated to another material (UI—unit integrator—unit that receives the other material) or that a material was integrated to a work environment (UI) internal or external (5 or 4).

30. “Traceability system applied to farm production activities, industrialization and commercialization of bee products”, according with claim 1, characterized by containing a data acquisition process (PAD) that, when it executes the readings of sets of pairs of RFID or bar codes (LCB), the reading of the first entity, followed by the reading of the code of the second, means for the system that the second was made available to the first entity (UI); however, when the reading of the first entity is executed and this has a code of the class of consumables (6), this means for the system (PAD) that this material was yielded to the entity identified by the code read in the sequence (UI).

31. “Traceability system applied to farm production activities, industrialization and commercialization of bee products”, according with claim 1, characterized by containing a data acquisition process (PAD) that is executed with the traceability equipment (A) by reading sets of pairs of RFID or bar codes (LCB), and when reading the code of the first entity (UI) followed by the reading of the code of several other entities (these recognized ones for the PAD as apt to form pairs with the first one) means for the system (PAD) that all the others had been yielded to the first one (UI). It is not necessary to read the first entity (UI) for repeated times preceding the reading of each one of the others that will be integrated, to indicate the formation of pairs of codes.

32. “Traceability system applied to farm production activities, industrialization and commercialization of bee products”, according with claim 1, characterized by the fact that the data acquisition process (PAD) registers activities with the traceability equipment (A) through the reading of sets of RFID or bar codes (LCB), where the reading of the code of an entity which integrates another entity (integrating unit UI) means to the system (PAD) that the job is being executed in this unit (UI), even if the code of the integrating unit (UI) has not been read.

33. “Traceability system applied to farm production activities, industrialization and commercialization of bee products”, according with claim 1, characterized by the following feature of the data acquisition process (PAD), executed with the traceability equipment (A) through the reading of unitary sets or pairs of RFID or bar codes (LCB): when it reads the code of an entity which is an integrant part of another one (UI), independently of having read the code of the integrator entity (UI), and in the sequence it reads the code of another entity, which integrates another integrator unit (UI), the system will understand that the work that was being carried through inside of the previous unit (UI) has finished, and another work in another unit (UI) has initiated.

34. “Traceability system applied to farm production activities, industrialization and commercialization of bee products”, according with claim 1 characterized by having the data acquisition process (PAD), and all the wooden materials (hive frames, boxes, covers and bottom board) used to lodge a beehive, that are marked with individual codes (bars or RFID), ordered in classes and subclasses, optionally can receive pyrographic marking with the same number of the bar code, to serve as identification in eventual loss or damage of the code label or as patrimony identification.

35. “Traceability system applied to farm production activities, industrialization and commercialization of bee products”, according with claim 1, characterized by the execution of the logistic process (PL) to have the workplaces divided in internal (5) and external (4) environments.

36. “Traceability system applied to farm production activities, industrialization and commercialization of bee products”, according with claim 1, characterized by the execution of the logistic process (PL) to have in internal workplaces two types of sections: one that receives materials or products, executes a processing and release to another section; and another one that receives materials or products for transitory deposit and executes no processing.

37. “Traceability system applied to farm production activities, industrialization and commercialization of bee products”, according with claim 1, characterized by having in the execution of the logistic process (PL) the sections of the internal workplaces divided in sub-areas, duly identified by marks on the ground, as well as by RFID or bar code (LCB).

38. “Traceability system applied to farm production activities, industrialization and commercialization of bee products”, according with claim 1, characterized by containing a logistic process (PL) whose execution needs the sections of internal workplaces (the ones that receive material or product, process and release for another section) to be subdivided in entrance sub-areas and exit sub-areas, also duly identified by marks on the ground and by RFID or bar codes (LCB).

39. “Traceability system applied to farm production activities, industrialization and commercialization of bee products”, according with claim 1, characterized by not being necessary the reading of the code of an item being removed from a unit integrator (UI) during the execution of the logistic process (PL), either in internal or external environment. The reading is only—required for the insertion of the item in the new unit (UI), meaning that, for this operation, it is not necessary to indicate the withdrawal of the item from the previous environment, but the simple addition in the subsequent environment indicates for the data acquisition process (PAD) that it has been removed from the previous one.

40. “Traceability system applied to farm production activities, industrialization and commercialization of bee products”, according with the claim 1, characterized by—implementing security requirements (SS) for the acquisition (SS1), the storage (SS2), the interpretation (SS3) and availability (SS4) of the data.

41. “Traceability system applied to farm production activities, industrialization and commercialization of bee products”, according with claim 1, characterized by the security system for the data acquisition (SS1), inserted in the logic of the firmware, a software (SW) embedded in the traceability equipment (A), which establishes mandatory procedures that induce the professional carrying the traceability equipment (A) to correctly collect data, preventing such professional of forgetting to collect essential data for guaranteeing the product traceability.

42. “Traceability system applied to farm production activities, industrialization and commercialization of bee products”, according with claim 1, characterized by the security system (SS1) inserted in the logic of the firmware, a software (SW) embedded in the traceability equipment (A) with the purpose alert the user about the insertion of data in the mandatory procedures, it has a device that induces the traceability equipment (A) to emit sound and luminous signals, whenever a mandatory procedure is not fulfilled.

43. “Traceability system applied to farm production activities, industrialization and commercialization of bee products”, according with claim 1, characterized by the security system (SS1) inserted in the logic of the firmware, a software (SW) embedded in the traceability equipment (A) which, according to the stages with mandatory procedures in predetermined sequence, has as first procedure, the procedure of removing the traceability equipment (A) from the base (A1), and it can only be executed by the operator employee (1).

44. “Traceability system applied to farm production activities, industrialization and commercialization of bee products”, according with claim 1, characterized by the security system (SS1) inserted in the logic of the firmware, a software (SW) embedded in the traceability equipment (A) which, according to stages with mandatory procedures in predetermined sequence, has as second procedure, the procedure executed by the operator employee (1) after removing the traceability equipment (A) from the base (A1): to identify itself through the reading of its own code (LCB or RFID) in a period of time predetermined by the software (SW).

45. “Traceability system applied to farm production activities, industrialization and commercialization of bee products”, according with claim 1, characterized by the security system (SS1) inserted in the logic of the firmware, a software (SW) embedded in the traceability equipment (A), to have an agenda.

46. “Traceability system applied to farm production activities, industrialization and commercialization of bee products”, according with claim 1, characterized by the security system (SS1) inserted in the logic of the firmware, a software (SW) embedded in the traceability equipment (A) which, according to stages with mandatory 5 procedures in predetermined sequence, having as third procedure the procedure in which the operator employee (1) chooses in the menu of the traceability equipment (A) the option “agenda”.

47. “Traceability system applied to farm production 10 activities, industrialization and commercialization of bee products”, according with claim 1, characterized by the security system (SS1) inserted in the logic of the firmware, a software (SW) embedded in the traceability equipment (A), containing in the agenda with IEJ mandatory reading, information about the other employees (2) of the team, about the vehicle (3) that it will be used, about the location of the materials that must be taken, about the route that must be followed, about the places that must be visited and the works that will be carried through.

48. “Traceability system applied to farm production activities, industrialization and commercialization of bee products”, according claim 1, characterized by the security system (SS1) inserted in the logic of the firmware, a software (SW) embedded in the traceability equipment (A) which, according to stages with mandatory procedures in predetermined sequence, has as fourth procedure the insertion of information through the reading of code or choice in the agenda menu, about the staff team (2) that will follow the operator employee (1) and the vehicle (3) that will be used, confirming or not what was foreseen in the agenda.

49. “Traceability system applied to farm production activities, industrialization and commercialization of bee products”, according with claim 1, characterized by the security system (SS1) inserted in the logic of the firmware, a software (SW) that is embedded in the traceability equipment (A) that, according to stages with mandatory procedures in predetermined sequence, has as fifth procedure the procedure of executing the reading of the code (joint unitary) of the place of the expedition (5.2.1), where there is also material to be collected and taken to the field.

50. “Traceability system applied to farm production activities, industrialization and commercialization of bee products”, according with claim 1, characterized by the security system (SS1) inserted in the logic of the firmware, a software (SW) embedded in the traceability equipment (A), which contains a function that turns on the alarm of the device, starting the emission of sonorous and luminous signals whenever the user do not insert information in the traceability equipment (A) about the other employees (2) who will follow the operator employee (1), or about the vehicle (3) that will be used, before executing the reading of the code (joint unitary) of the place of the expedition (5.2.1) where the material is being collected to be taken to the field.

51. “Traceability system applied to farm production activities, industrialization and commercialization of bee products”, according with claim 1, characterized by the security system (SS1) inserted in the logic of the firmware, a software (SW) embedded in the traceability equipment (A), which contains a function that turns on the alarm of the device, starting the emission of sonorous and luminous signals whenever the user does not execute the reading of the code (joint unitary) of the place of the expedition (5.2.1), where the material has been collected to be taken to the field, and the user leaves the expedition to a distance of an amount of meters above (verified by GPS) what was configured in the software (SW).

52. “Traceability system applied to farm production activities, industrialization and commercialization of bee products”, according with claim 1, characterized by the security system (SS1) inserted in the logic of the firmware, a software (SW) embedded in the traceability equipment (A), which contains a function to monitor the traceability equipment (A), by turning on and executing the reading of the geographic coordinates from time to time (minutes) in accordance with what was previously configured in software (SW).

53. “Traceability system applied to farm production activities, industrialization and commercialization of bee products”, according with claim 1, characterized by the security system (SS1) inserted in the logic of the firmware, a software (SW) embedded in the traceability equipment (A), which contains a function that, since being monitored by GPS, indicates to the carrier of the equipment (with sonorous and luminous signals) when the vehicle leaves the programmed route.

54. “Traceability system applied to farm production activities, industrialization and commercialization of bee products”, according with claim 1, characterized by the functioning of the security system of data storage (SS2), the software (SW) embedded in the traceability hardware (HW) implements a security requirement that registers in the internal memory of the hardware (HW), all the dates and hours that the traceability hardware (HW) was physically opened.

55. “Traceability system applied to farm production activities, industrialization and commercialization of bee products”, according with claim 1, characterized by the security system for data interpretation (SS3) inserted in the logic of the firmware, a software (SW) embedded in the traceability equipment (A), that implements a security requirement to automatic generation of signatures (keys of 128 bits) for each set of information collected by the traceability equipment (A). Each time that the traceability equipment (A) transfers the collected data to the management software (SWG) these signatures are stored in the non-volatile memory on the board of the traceability equipment (A) until its qualification, when these signatures will be compared with the signatures of the documentation generated and published by the user, thus validating or not the veracity of the generated traceability documents.

56. “Traceability system applied to farm production activities, industrialization and commercialization of bee products”, according with claim 1, characterized by the security system for data availability (SS4) inserted in the logic of the firmware, a software (SW) that is embedded in the traceability equipment (A), that implements a security requirement that crosses the information of global position (GPS) with the ones of reading of unitary sets or pairs of codes (RFID or bar code), in order to validate the operations carried through.

57. “Traceability system applied to farm production activities, industrialization and commercialization of bee products”, according with claim 1, characterized by the security system for data availability (SS4) inserted in the logic of the firmware, a software (SW) embedded in the traceability equipment (A), that implements a security requirement that compares collected data with the same type of data previously collected, crossing information as time of execution, measures of GPS, amount of involved employees, codes, executed task, makes statistical treatment and records the result of probability of adulteration of the acquired data.

58. “Traceability system applied to farm production activities, industrialization and commercialization of bee products”, according with the claim 1, characterized by the traceability equipment (A), which contains a wireless communication system for long distances (CW) which binds the central operational management center (C) to the traceability equipment (A) and makes available a communication channel for sending messages in the two directions, even if the operator (1) is distant from the central office (C).
